(19) United States
(12) Patent Application Publication
(10) Pub. No.: US 2009/0107328 A1
(43) Pub. Date: Apr. 30, 2009

(54) Reciprocating Pump

(75) Inventors: Alan Robert Burns, Western Australia (AU); Peter Tinc, Western Australia (AU)

Correspondence Address: MERCHANT & GOULD PC, P.O. BOX 2903, MINNEAPOLIS, MN, 55402-0903, US

(73) Assignee: SEAPOWER PACIFIC PTY LTD., West Perth, Western Australia (AU)

(21) Appl. No.: 11/994,268

(22) PCT Filed: Jun. 30, 2006
(86) PCT No.: PCT/AU2006/000928

§ 371 Date: Jul. 21, 2008

(30) Foreign Application Priority Data
Jun. 30, 2005 (AU) 2005903457

(51) Int. Cl. F16J 15/16

(52) U.S. Cl. 92/165 R

(57) ABSTRACT

A reciprocating pump (10) comprises a body (11) configured as a cylindrical pressure vessel defining an internal space (13). The body (11) comprises a wall (17) having an opening (18) therein. The pump (10) further comprises a reciprocating plunger (25) having a cylindrical side face (26) and an end face (27). The plunger (25) extends into the internal space (13) through the opening (18) within the wall (17). A seal means (40) is provided for establishing a fluid seal between the body (11) and the plunger (25) at the opening (18). The seal means (40) is adapted to accommodate limited tilting movement of the plunger (25) with respect to the body (11). The seal means (40) comprises a bush (43) with which the plunger (25) is in sliding and sealing engagement. The bush (43) is supported in a mount (45) and is moveable with respect thereto to accommodate the limited tilting movement of the plunger (25).

### FIELD OF THE INVENTION

This relates to a reciprocating pump.

The invention has been devised particularly for pumping seawater at high pressure. It should, however, be understood that the invention may find application for pumping of various fluids other than seawater.

### BACKGROUND ART

International application PCT/AU03/00813 discloses an apparatus for harnessing wave energy and converting the wave energy to pressurised seawater. The seawater is drawn from the ocean environment in which the apparatus operates and is pumped under high pressure to shore for utilisation there.

Pumping of seawater at high pressure, possibly in access of 70 bar, utilising reciprocating pump powered by wave energy (and thus likely to have a relatively slow moving, variable stroke) can present technical difficulties. The pump may, for example, be required to operate with irregular and non-sinusoidal strokes (as may be produced from a drive train powered directly by a renewable energy source such as wave motion). Further, there may be need to tolerate a degree of misalignment; that is, tilting of the piston axis.

It is against this background, and the problems and difficulties associated therewith, that the present invention has been developed.

### DISCLOSURE OF THE INVENTION

According to one aspect of the invention there is provided a reciprocating pump comprising a body defining an internal space and an opening onto the internal space, a plunger extending through the opening into the internal space whereby a pumping chamber is defined within the internal space between the body and the plunger and whereby reciprocatory movement of the plunger effects volume change within the pumping chamber, and a seal means providing a fluid seal between the body and the plunger at the opening, the seal means being adapted to accommodate limited tilting movement of the plunger with respect to the body.

Preferably, the seal means comprises a bush with which the plunger is in sliding and sealing engagement, the bush being supported in a mount and being moveable with respect thereto to accommodate said limited tilting movement of the plunger.

Preferably, interfaces at which the bush and the mount are in contact are profiled to accommodate said movement therebetween. Such interfaces may, for example, be of spherical configuration for angular movement therebetween.

Preferably, the bush is of annular configuration, comprising a radially inner side for sliding and sealing engagement with the plunger. The radially inner side may include one or more sealing rings providing sliding and sealing engagement with the plunger. The bush may further comprise a radially outer side, and two end faces extending between the radially inner and outer sides.

Preferably, the mount comprises an annular cavity in which the bush is accommodated, the annular cavity having two opposed seat faces for supporting the end faces of the bush. With this arrangement, contact between the seat faces of the mount and the end faces of the bush provide said interfaces for accommodating movement between the bush and the mount. Such movement is angular sliding movement of the bush with respect to the mount.

Preferably, the mount comprises a further face extending between the seat faces, said further face being spaced from the outer side of the bush.

Preferably, a resistive means is provided for yieldingly resisting angular sliding movement of the bush relative to the mount from a first (normal) condition. The resistive means may comprise a resiliently compressible body accommodated in the space between the outer side of the bush and said further face of the mount. Conveniently, the resiliently compressible body comprises an elastic ring.

The mount may comprise a plurality of parts adapted to be assembled together. This facilitates access to the annular cavity therein for installation of the bush, and may also assist in fabrication of the mount.

### BRIEF DESCRIPTION OF THE DRAWINGS

The invention will be better understood by reference to the following description of two specific embodiments thereof as shown in the accompanying drawings in which:

FIG. 1 is schematic sectional elevational view of a reciprocating pump according to the first embodiment;

FIG. 2 is a side view of the pump;

FIG. 3 is a plan view of the pump;

FIGS. 4, 5 and 6 are schematic cross-sectional views showing the pump with the plunger thereof in various operational positions;

FIG. 7 is a fragmentary view illustrating in particular a seal means between the plunger and the pump body; and

FIG. 8 is a view of a seal means for a pump according to a second embodiment.

### BEST MODE(S) FOR CARRYING OUT THE INVENTION

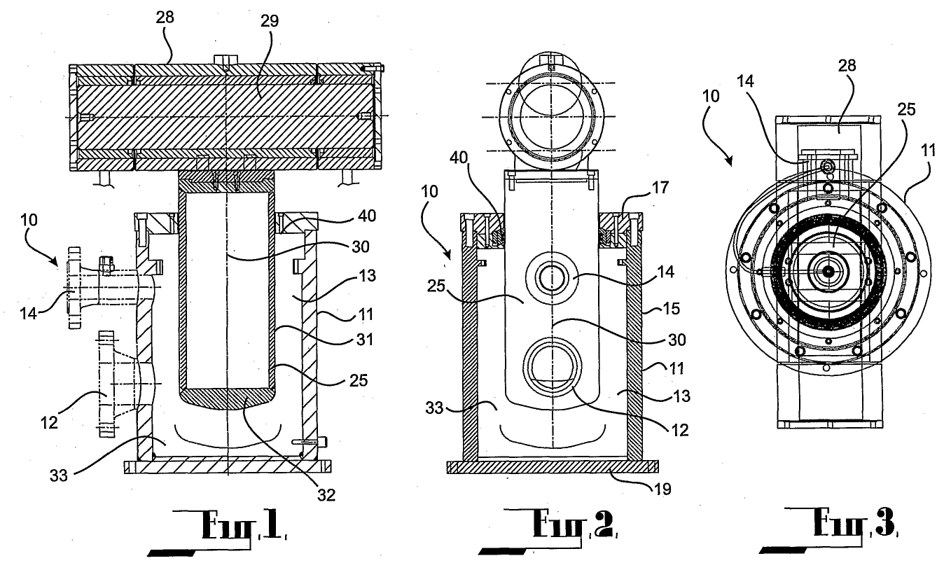

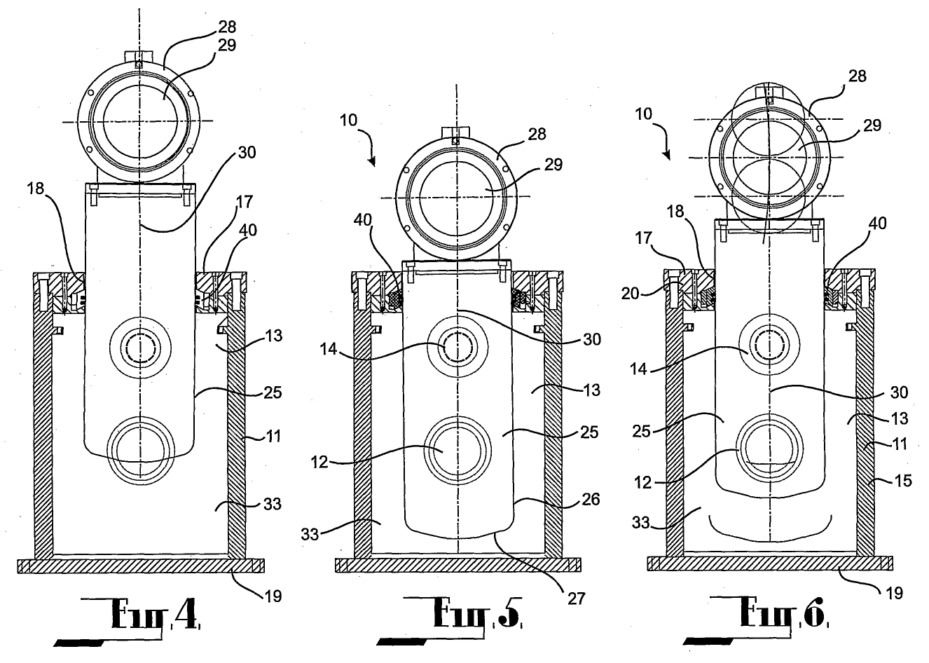

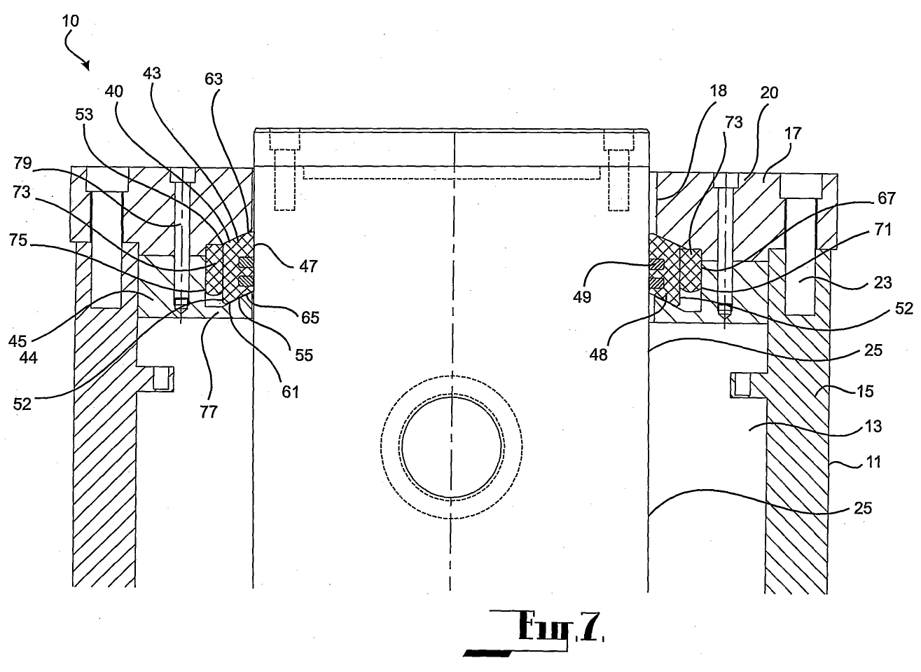

Referring to FIGS. 1 to 7 of the drawings, there is shown a reciprocating pump 10 according to a first embodiment which is particularly suitable for pumping seawater. The seawater is drawn from the ocean itself and thus has an initial pressure corresponding to the hydrostatic pressure at the ocean depth from which the seawater is drawn.

Where the pump 10 is powered by wave energy, it typically operates with a slow-moving, variable stroke. The pump 10 is of a construction particularly suited to such an application.

The pump 10 comprises a body 11 configured as a cylindrical pressure vessel defining an internal space 13. The body 11 comprises a cylindrical side wall 15 and an end wall 17 at one end of the cylindrical side wall 15. The end wall 17 has an opening 18 therein. The other end of the cylindrical side wall 15 is closed by a base 19.

The end wall 17 is defined by an end plate 20 detachably connected to the cylindrical side wall 15, the detachable connection in this embodiment being provided by machine screw fasteners 23.

The pump 10 further comprises a plunger 25 having a cylindrical side face 26 and an end face 27. The plunger 25 is attached to a connector 28 adapted to undergo reciprocatory motion under the influence of a drive train powered by, for example, wave motion. In this embodiment, the connector 28 is configured as a hinge bush which receives a hinge pin 29 connected to a lever (not shown), whereby reciprocation of the lever imparts reciprocatory motion to the plunger 25. The axis of reciprocation of the plunger 25 corresponds to its central longitudinal axis 30. The plunger 25 is of hollow construction, and includes a cylindrical side wall portion 31 defining the side face 26 and an end wall portion 32 defining the end face 27, as shown in FIG. 1.

The plunger 25 extends into the internal space 13 through the opening 18 within the end wall 17, whereby a pumping chamber 33 is defined between within the internal space 13 between the plunger 25 and the body 11. With this arrangement, reciprocatory movement of the plunger 25 within the internal space 13 effects a change of volume of the pumping chamber 33, as illustrated in FIGS. 4, 5 and 6.

The outer surface of the plunger 25 may be coated with a corrosion resistant and robust material, such as molybdenum.

The body 11 incorporates an inlet 12 and an outlet 14, both of which communicate with the pumping chamber 33.

While not shown in the drawings, the pump 10 also comprises a suitable arrangement of valves for controlling the direction of fluid flow through inlet 12 into the pumping chamber 33 and out of the pumping chamber 33 through outlet 14.

A seal means 40 is provided for establishing a fluid seal between the body 11 and the plunger 25 at the opening 18. The seal means 40 is adapted to accommodate limited tilting movement of the plunger 25 with respect to the body 11.

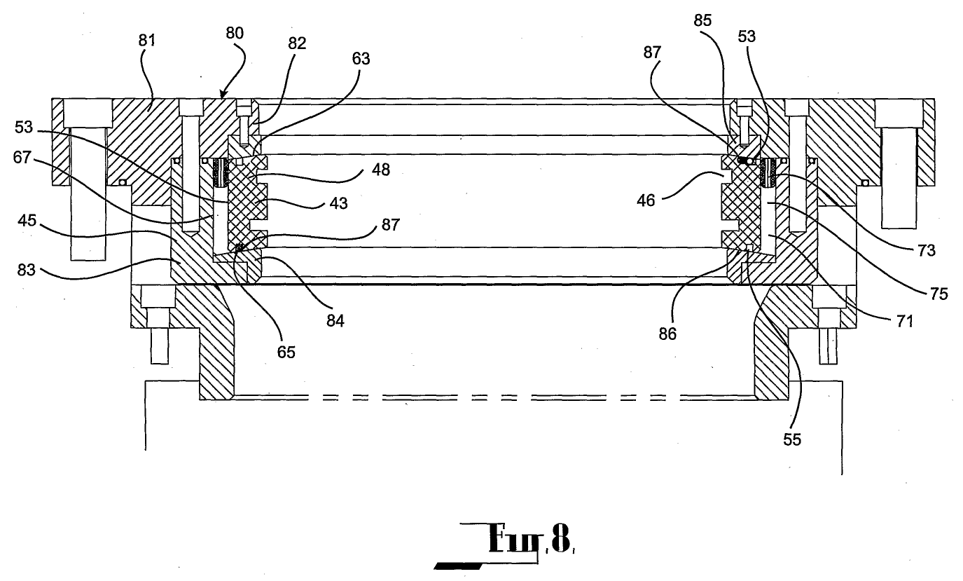

As best seen in FIG. 7, the seal means 40 comprises a bush 43 with which the plunger 25 is in sliding and sealing engagement.

The bush 43 supported in a mount 45 and is moveable with respect thereto to accommodate the limited tilting movement of the plunger 25.

The bush 43 is of annular configuration, comprising a radially inner side 47 for sliding and sealing engagement with the plunger 25. The inner side 47 includes two axially spaced sealing rings 49 providing sliding and sealing engagement with the plunger 25. The bush 43 further comprise a radially outer side 52, and two end faces 53, 55 extending between the radially inner and outer sides 47, 52. The end faces 53, 55 are of a spherical profile.

The bush 43 comprises a bush body 48 supporting the sealing rings 49. The bush body 48 can be made of any appropriate material; for example, a polymer bearing material incorporating an internal lubricant, such as advanced engineering thermoplastic incorporating a PTFE internal lubricant (an example of which is Vesconite Hilube™). Similarly, the sealing rings 49 can be of any appropriate material and construction, such as Shamban Stepseal Turcite™

The mount 45 comprises an annular cavity 61 in which the bush 43 is accommodated. The annular cavity 61 has two opposed seat faces 63, 65 for supporting the end faces 53, 55 of the bush 43. The mount seat faces 63, 65 are of a spherical profile matching that of the bush end faces 53, 55. With this arrangement, contact between the mount seat faces 63, 65 and the bush end faces 53, 55 accommodates angular sliding movement of the bush 43 with respect to the mount 45. In this way the bush 43 can accommodate any tilting and angular misalignment of the plunger 25 (within a limited rang).

The mount 45 also comprises a further face 67 extending between the seat faces 63, 65. The further face 67 is spaced from the outer side 52 of the bush 43 such that a gap 71 is defined therebetween.

A resiliently compressible body 73 is accommodated in the gap 71 and acts to yieldingly resisting angular sliding movement of the bush 43 relative to the mount 45 away from a first (normal) condition corresponding to alignment of the axis 30 of the plunger 25 with the body 11, or more particularly alignment of the plunger axis 30 with the central axis of the opening 18, as shown in the drawings. The resiliently compressible body 73 comprises an elastic ring. The elastic ring 73 does not fully occupy the gap 71, thereby leaving a void 75 within the gap 71 for accommodating distortion of the ring upon angular sliding movement of the bush 43 relative to the ring upon tilting of the plunger away from the first (normal) condition. The yielding resistance offered by the resiliently compressible body 73 serves to resist the tiling of the plunger away from the first (normal) condition but also serves to influence the plunger to return to that condition; that is, the resiliently compressible body 73 biases the plunger to the first (normal) condition.

Seawater within the pumping chamber 33 is utilised for lubrication of the bush 43

In this embodiment, the mount 45 comprises two parts, one being the end plate 20 and the other being a rigid inner ring 77 detachably mounted on the inner side of the end plate 20 by fasteners 79. The end plate 20 is configured to define the mount seat face 63, and the inner ring 77 is configured to define the mount seat face 65. This arrangement facilitates access to the annular cavity 61 for installation of the bush 43.

Referring now to FIG. 8 of the drawings, there is shown a seal means 80 for a pump according to a second embodiment. The seal means 80 is similar in some respects to the seal means 40 of the pump according to the first embodiment and so like reference numerals are used to identify corresponding parts.

In this embodiment, the mount 45 comprises five parts for ease of manufacture. The five parts comprise end plate 81 for attachment to the pump body 11, insert 82 with the end plate, inner ring 83 detachably mounted on the end plate, an inner seat member 84 supported on the inner ring 83, and outer seat member 85 mounted on the inner side of the insert 82. The outer seat member 85 is configured to define mount seat face 63, and the inner seat member 84 is configured to define mount seat face 65.

The bush body 48 and the outer seat member 85 are any appropriate material; for example, a polymer bearing material incorporating an internal lubricant, such as advanced engineering thermoplastic incorporating a PTFE internal lubricant. The inner ring 83 and the inner seat member 84 are chrome-plated for corrosion resistance.

Each bush end face 53, 55 incorporates a channel 86 which accommodates a sealing ring 87 for providing a fluid seal between the contacting faces of the bush 43 and the mount 45.

The bush 43 is shown with annular recesses 46 on the bush body 48 for accommodating the sealing rings but the latter are not shown.

The present embodiments each provide a simple, yet highly effective, pump that can perform in harsh environments. Because of its construction, the pump is able to operate with the irregular and non-sinusoidal strokes arising from a drive system powered by wave energy. Because of the construction of the respective seal means 40, 80 between the plunger 25 and the pump body 11, a degree of misalignment between the plunger 25 and the pump body 11 can be tolerated.

It should be appreciated that the scope of the invention is not limited to the scope of the embodiments described. For example, while the pumps according to the embodiments have been described in relation to pumping of seawater, a pump according to the invention may find application in the pumping of various other fluid materials, including liquids, gases and slurries.

Modifications and changes can be made without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A reciprocating pump comprising a body defining an internal space and an opening onto the internal space, a plunger extending through the opening into the internal space whereby a pumping chamber is defined within the internal space between the body and the plunger and whereby reciprocatory movement of the plunger effects volume change within the pumping chamber, and a seal means providing a fluid seal between the body and the plunger at the opening, the seal means being adapted to accommodate limited tilting movement of the plunger with respect to the body.

2. A reciprocating pump according to claim 1 wherein the seal means comprises a bush with which the plunger is in sliding and sealing engagement, the bush being supported in a mount and being moveable with respect thereto to accommodate said limited tilting movement of the plunger.

3. A reciprocating pump according to claim 1 wherein interfaces at which the bush and the mount are in contact are profiled to accommodate said movement therebetween.

4. A reciprocating pump according to claim 3 wherein the interfaces are of spherical configuration for angular movement therebetween.

5. A reciprocating pump according to claim 1 wherein the bush is of annular configuration, comprising a radially inner side for sliding and sealing engagement with the plunger.

6. A reciprocating pump according to claim 6 wherein the radially inner side includes one or more sealing rings providing sliding and sealing engagement with the plunger.

7. A reciprocating pump according to claim 5 wherein the bush further comprises a radially outer side, and two end faces extending between the radially inner and outer sides.

8. A reciprocating pump according to claim 2 wherein the mount comprises an annular cavity in which the bush is accommodated, the annular cavity having two opposed seat faces for supporting the end faces of the bush.

9. A reciprocating pump according to claim 8 wherein the mount further comprises a further face extending between the seat faces, said further face being spaced from the outer side of the bush.

10. A reciprocating pump according to claim 2 wherein a resistive means is provided for yieldingly resisting angular sliding movement of the bush relative to the mount from a first (normal) condition.

11. A reciprocating pump according to claim 10 wherein the resistive means comprises a resiliently compressible body accommodated in the space between the outer side of the bush and said further face of the mount.

12. A reciprocating pump according to claim 11 wherein the resiliently compressible body comprises an elastic ring.

13. A reciprocating pump according to claim 2 wherein the mount comprise a plurality of parts adapted to be assembled together.

14. (canceled)
